(19) United States
(12) Patent Application Publication
(10) Pub. No.: US 2026/0015084 A1
(43) Pub. Date: Jan. 15, 2026

(54) METHODS AND APPARATUS FOR REUSABLE ENERGY ABSORBING LAYERS

(71) Applicant: Quality Research, Development & Consulting, Inc., Wayzata, MN (US)

(72) Inventor: Daryoush Allaei, Wayzata, MN (US)

(21) Appl. No.: 19/269,374

(22) Filed: Jul. 15, 2025

Related U.S. Application Data
(60) Provisional application No. 63/671,455, filed on Jul. 15, 2024.
(60) Provisional application No. 63/741,474, filed on Jan. 3, 2025.

(51) Int. Cl. B64D 1/14; B64D 9/00

(52) U.S. Cl. CPC B64D 1/14; B64D 9/00

(57) ABSTRACT

An apparatus includes an airdrop load and at least one energy absorbing assembly including a grid formed from a plurality of layers. Each layer includes: a plurality of slots sufficient to accommodate a thickness of others layers from the plurality of layers and form a plurality of joints; a plurality of apertures, each aperture from the plurality of apertures colinear with a joint from the plurality of joints along a vertical axis; and a plurality of bosses, each boss from the plurality of bosses protruding into a slot from the plurality of slots and having a complementary geometry and position to engage with an aperture from a plurality of apertures of an adjacent layer from the plurality of layers when the grid is formed.

### CROSS-REFERENCE TO RELATED APPLICATION

This application claims priority to U.S. Provisional Patent Application Ser. No. 63/671,455, filed on Jul. 15, 2024, and U.S. Provisional Patent Application Ser. No. 63/741,474, filed on Jul. 15, 2024, the contents of each of which are hereby incorporated by reference in entirety.

### BACKGROUND

Energy absorbing layers can be implemented for the transporting and/or paradropping of shipping items. The energy absorbing layers or dissipation pads can be placed under shipping items, on the sides of the shipping items, and on top of the shipping items, and can provide a surface for the shipping items to be placed or to be surrounded by.

### SUMMARY OF THE INVENTION

In an aspect of the invention, an apparatus includes an airdrop load and at least one energy absorbing assembly including a grid formed from a plurality of layers. Each layer includes: a plurality of slots sufficient to accommodate a thickness of others layers from the plurality of layers and form a plurality of joints; a plurality of apertures, each aperture from the plurality of apertures colinear with a joint from the plurality of joints along a vertical axis; and a plurality of bosses, each boss from the plurality of bosses protruding into a slot from the plurality of slots and having a complementary geometry and position to engage with an aperture from a plurality of apertures of an adjacent layer from the plurality of layers when the grid is formed. At least one of the (at least one) energy absorbing assemblies is positioned below or within the airdrop load such that the grid of the energy absorbing assembly is at least partially perpendicular to an anticipated impact vector.

The plurality of layers may be comp of elastomer. The plurality of slots may include at least three slots. The plurality of slots may be defined by a surface of respective layer. The plurality of slots may be defined by different surfaces of a respective layer. The shapes of each of the plurality of slots may be uniform. A width-defining surface of a layer of the plurality of layers may define one or more apertures. A layer of the plurality of layers may have one or more air pockets. A layer of the plurality of layers may have one or more metal-filled pockets. The plurality of joints may include halved joints. Each aperture may be offset from a joint of the plurality of joints. Each aperture may be colinear with adjacent apertures along a horizontal axis.

The shapes of each of the apertures may be uniform. Each layer may be composed of rubber, including styrene-butadiene rubber. The plurality of layers may be configured to be assembled to form at least one polygon. The grid may be a square grid, a 2×2 rectangular grid, a rectangular grid, or a triangular grid.

A layer from the plurality of layers may include a first boss and a second boss from the plurality of bosses, wherein each of the first boss and the second boss protrudes inward into a slot for that layer and from opposite sides of the slot such that each of the first boss and the second boss converge towards a center of the slot without establishing contact. One or more layers of the plurality of layers may have a floatation device attached.

In another aspect of the invention, a method includes positioning the at least one energy absorbing assembly according to claim 1 on a skid board and within the airdrop load such that the grid of the at least one energy absorbing assembly is at least partially perpendicular to the anticipated impact vector.

### BRIEF DESCRIPTION OF THE DRAWINGS

FIG. 1 is an illustrative representation of a system for reusable energy absorbing layers, according to some embodiment.

FIGS. 2A-2C are illustrative representations of modules of reusable energy absorbing layers of the system of FIG. 1, according to some embodiments.

FIGS. 3A-3B are illustrative representations of reusable energy absorbing layers, according to some embodiments.

FIGS. 4A-4D are diagrammatic illustrations of slots and bosses of reusable energy absorbing layers, according to some embodiments.

FIGS. 5A-5B are illustrative representations of a reusable skid board of the system of FIG. 1 with various combination of modules, according to some embodiments.

FIGS. 6-7 are illustrative representations of folded modules of reusable energy absorbing layers, according to some embodiments.

FIG. 8 is an illustrative representation of the system for reusable energy absorbing layers of FIG. 1 with load, according to some embodiments.

FIG. 9 is a flow diagram of a method for positioning the reusable energy absorbing layers within an airdrop load, according to some embodiments.

FIGS. 10A-10B are illustrative representations of a skid board having a groove between a set of holes.

FIG. 11 is a drawing of a skid board having a groove between each of several sets of holes.

FIGS. 12A-12B are illustrative representations of modules of reusable energy absorbing layers with affixed floatation devices.

FIG. 12C is an illustrative representation of a belt with affixed floatation devices.

FIG. 13 is a table showing examples of modules of varying sizes and numbers of leaves, and corresponding load capacities.

### DETAILED DESCRIPTIONS

In some embodiments, energy absorbing layers or energy dissipation pads are described herein. The energy dissipation pad/layer or energy absorbing layer (also referred to herein as “layer”) can be an elastomer-based, modular, and adaptable. The energy absorbing layer can be assembled by a packager, which allows for reduced shipping volumes of separate pieces as well as decreased storage volume. The energy absorbing layer can include multiple slits that combine with other energy absorbing layers to make a larger assembly, namely pods.

The energy absorbing layer can have several advantages over traditional energy absorbing layers. For instance, the design of the energy absorbing layer described herein can allow for smaller shipping volume (prior to assembly), can be assembled on-site, and is reusable. The use of elastomer material allows for its reusability and makes the layer impervious to environmental conditions including, but not limited to, moisture (which, in addition to potentially reducing performance or lifespan of a traditional paper honeycomb layer, increases weight, which impacts the effective cargo capacity and/or range of an airplane carrying the layer. One assembly of the energy absorbing layers can be used for well over a five-years' worth of shipping items. In some implementations, the energy absorbing layers described herein can be composed of SBR (Styrene-Butadiene Rubber).

In some embodiments, the energy absorbing layer can include a board that is generally rectangular in shape and configured for coupling to one another to form a module of energy absorbing layers. For example, each layer can each define a number of slots along a given surface of the layer. The layer can be configured for receiving another layer within a defined slot. In some cases, the layer can be configured to receive a corresponding slot defined by another layer.

The energy-absorbing layers can have a variety of colors (e.g., black, white, off-white, orange, blaze orange, international orange, and the like) to be more or less conspicuous.

The energy absorbing layers described herein can be composed of different compositions. For example, the energy absorbing layers can be composed of an elastomeric material. The elastomeric material can include a polymer such as a polyolefins (e.g., polyethylene, polypropylene, polymethylpentene, polybutene-1, polyisobutylene, ethylene propylene rubber, ethylene propylene diene rubber, and the like), acrylonitrile-butadiene rubber, hydrogenated acrylonitrile-butadiene rubber, fluorocarbon rubber, perfluoroelastomer, silicone rubber, fluorosilicone rubber, chloroprene rubber, neoprene rubber, polyester urethane, polyether urethane, natural rubber, polyacrylate rubber, ethylene acrylic, styrene-butadiene rubber, ethylene oxide epichlorodrine rubber, chlorosulfonated polytethylene, butadiene rubber, isoprene rubber, butyl rubber, and the like. In some cases, plastic or metals can be used as part of the composition. In some cases, the energy absorbing layers can be filled with air pockets (e.g., during the manufacturing process) to further reduce weight, and may improve the ability of the energy absorbing layers to float in water. In some cases, the energy absorbing layers can be filled with pockets of metal, or some other dense material (e.g., during the manufacturing process), which can improve the ability of the energy absorbing layers to sink in water. Additionally, energy absorbing layers can include pockets composed of air, or other fluid. The pockets can modify the buoyancy of the energy absorbing layers. The pockets can impact the performance characteristics of the energy absorbing layers as well. Other materials can be utilized such as cardboard and wood (e.g., dimensional lumber, hardboard, plywood, OSB, and the like).

In some embodiments, the layer can include a mechanical device adapted and configured to allow compression, but retard rebounding. For example, a piston can quickly compress downward past ratcheting teeth that engage when the piston is pulled outward by rebound energy in a board to which the piston is attached. The ratcheting teeth can be attached to a spring (e.g., a leaf spring, coil spring, a spiral spring, a volute spring, and the like).

In some embodiments, the energy absorbing layers can include a mechanical device adapted and configured to allow compression, but retard rebounding. For example, a piston can quickly compress downward past ratcheting teeth that engage when the piston is pulled outward by rebound energy in a board to which the piston is attached. The ratcheting teeth can be attached to a spring (e.g., a leaf spring, coil spring, a spiral spring, a volute spring, and the like).

In some embodiments of the invention can include one or more features designed to minimizing rebound energy after impact, which could damage the cargo, e.g., by causing it to rotate on its side. The invention described herein can include one or more features designed to minimizing rebound energy after impact, which could damage the cargo, e.g., by causing it to rotate on its side. In some embodiment, the energy absorbing layers can include one or more frangible members that break upon impact to dissipate energy.

The energy absorbing layers as described herein can be reused for more than 100 drops (or airdrops) and can weigh around 4.4 pounds with a volume of around 101 in³. Compared to traditional storage, the energy absorbing layers have improved sustainability and take up significantly less volume and have less weight. For instance, the energy absorbing layers can exhibit a 95% to 99% improved sustainability and conserves around 127% water compared to similar systems using plywood. The energy absorbing layers can also be modular (e.g., easy to assemble without the need to cut or using glue or tape), adaptable (e.g., able to accommodate to various dimensions and sizes), and environmentally resistant (e.g., no degradation in water or moisture conditions).

In some cases, the composition can mitigate the overall weight of the energy absorbing layers (e.g., compared to conventional pads), can increase energy transfer through the layer, can facilitate the maintaining of the structural integrity of the layer (e.g., thereby allowing for multiple uses), and can be weather-resistant.

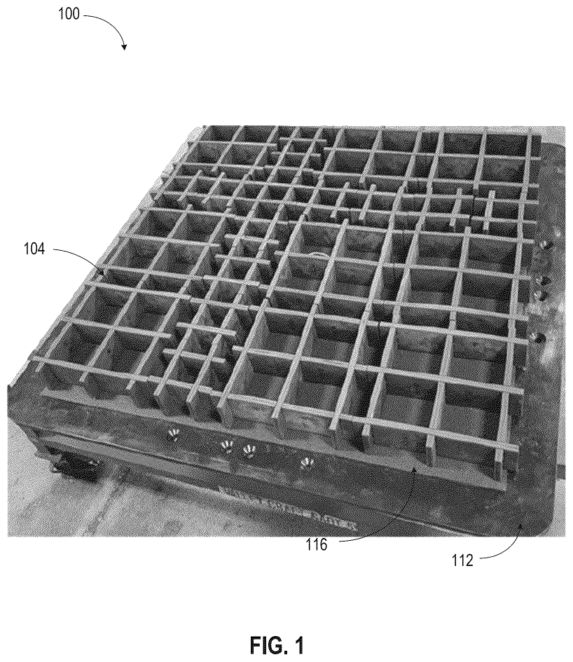

FIG. 1 is an illustrative representation of a system 100 for reusable energy absorbing layers 104, according to some embodiment. As shown in FIG. 1, the system 100 can include an assembly of one or more energy absorbing layers 104 (also referred to herein as “energy dissipation pads”), each of which are coupled to other layers and forming modules that are positioned adjacently with other modules of energy absorbing layers 104 and on top of a board 112. In some cases, the board 112 can be a skid board or platform and configured to withstand the weight of the energy absorbing layers 104 and other packages placed on top of the energy absorbing layers 104. In some implementations, the system 100 can also include a cushion 116 placed between the board 112 and the energy absorbing layers 104 to provide further support and dissipation of weight of load when positioned over the energy absorbing layers 104.

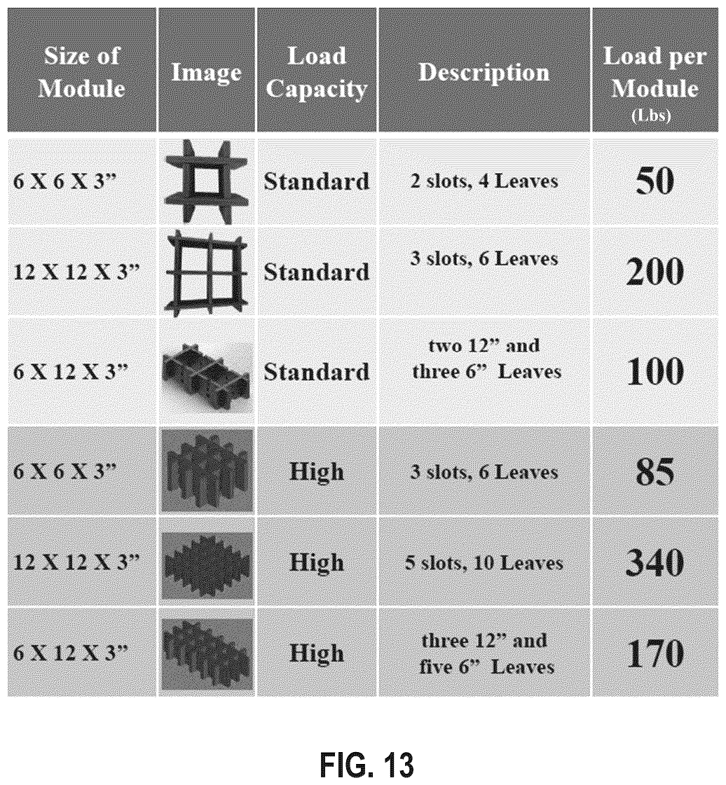

In some implementations, the modules of the energy absorbing layers can form a grid and be organized with other modules to form a larger grid as shown in FIG. 1. In some cases, each module can be positioned adjacent to each other and coupled to one another. For instance, the energy absorbing layers 104 of one module can be configured to receive or couple to the energy absorbing layers 104 of other modules (e.g., via defined slot, bosses, or protrusions of the energy absorbing layers 104). The modules may have larger cavities or smaller cavities, as seen for example in FIG. 13, which may affect the energy absorption performance of the modules. Modules with smaller cavities, i.e., more interlocking layers per unit area, may have a higher load capacity than modules with larger cavities, i.e., fewer interlocking layers per unit area. Modules may have varying colors to assist with identification and assembly.

In some implementations, depending on the size of the board 112 and/or the dimensions or total number of modules, assemblies, and/or grids of energy absorbing layers 104, the system 100 can support a load capacity of 1700 pounds. In some implementations, the energy absorbing layers 104 can each include one or more air pockets. In some implementations, the energy absorbing layers 104 can each include one or more metal-filled pockets

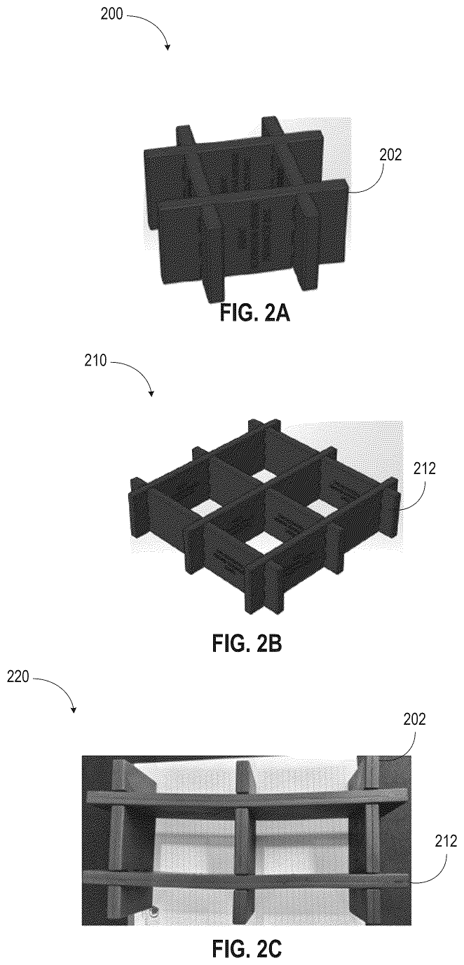

FIGS. 2A-2C are illustrative representations of modules of reusable energy absorbing layers of the system of FIG. 1, according to some embodiments. As shown in FIG. 2A, module 200 includes a set of energy absorbing layers in which each energy absorbing layer 202 of module 200 includes a set of at least two bosses, slots, and/or protrusions to allow for coupling with up to two other energy dis absorbing layers. In some implementations, four energy absorbing layers 202 can form the module 200. In some cases, the module 200 can have a weight of 1.4 pounds and can be 6 inches in length, 6 inches in width, and 3 inches in height. In some implementations, an assembly of modules 200 can be placed adjacent to each other to form the system 100 of FIG. 1.

As shown in FIG. 2B, module 210 can include a set of energy absorbing layers in which each energy absorbing layer 212 of module 210 includes a set of three bosses, slots, and/or protrusions to allow for coupling with up to three other energy absorbing layers. In some implementations, nine of the energy absorbing layers 212 can form the module 210 and can weigh 4.5 pounds and be 12 inches in length, 12 inches in width, and 3 inches in height.

As shown in FIG. 2C, module 220 can include a combination of energy absorbing layers 202 and energy absorbing layers 212 to form the module 220 and/or grid. The module 220 can be 1.2 pounds or 2.7 pounds (depending on type of material for the energy absorbing layers 202/212) and 6 inches in length, 6 inches in width, and 3 inches in height. In some implementations, any combination of modules can be formed using energy absorbing layer 202 or energy absorbing layer 212.

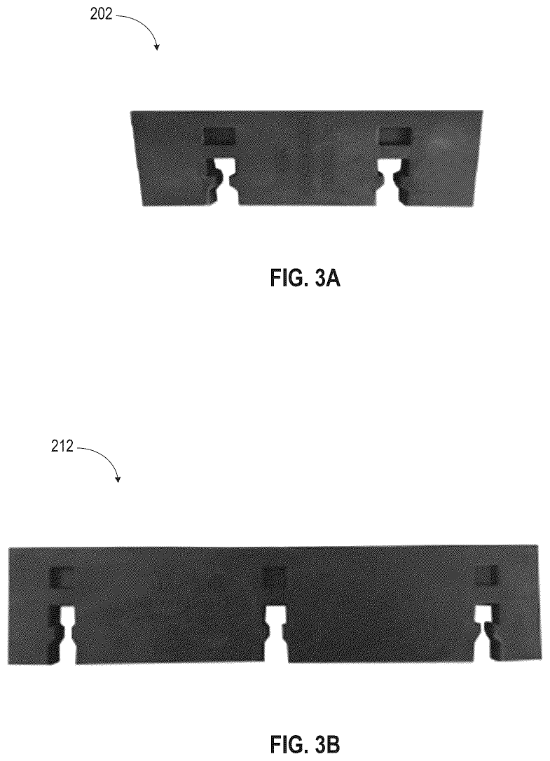

FIGS. 3A-3B are illustrative representations of reusable energy absorbing layers, according to some embodiments. As shown in FIG. 3A, energy absorbing layer 202 can include a set of two bosses, slots, and/or protrusions to allow for coupling with up to two other energy absorbing layers. Each energy absorbing layer 202 can weigh 0.39 pounds and be 6 inches in length, 3 inches in width, and 0.5 inches in height.

As shown in FIG. 3B, energy absorbing layer 212 can include a set of three bosses, slots, and/or protrusions to allow for coupling with up to three other energy absorbing layers. Each energy absorbing layer 212 can weigh 0.75 pounds and be 12 inches in length, 1 inch in width, and 3 inches in height. In some implementations, the energy absorbing layers can be composed of elastomer. In some implementations, the energy absorbing layers can be assembled to form at least one polygon.

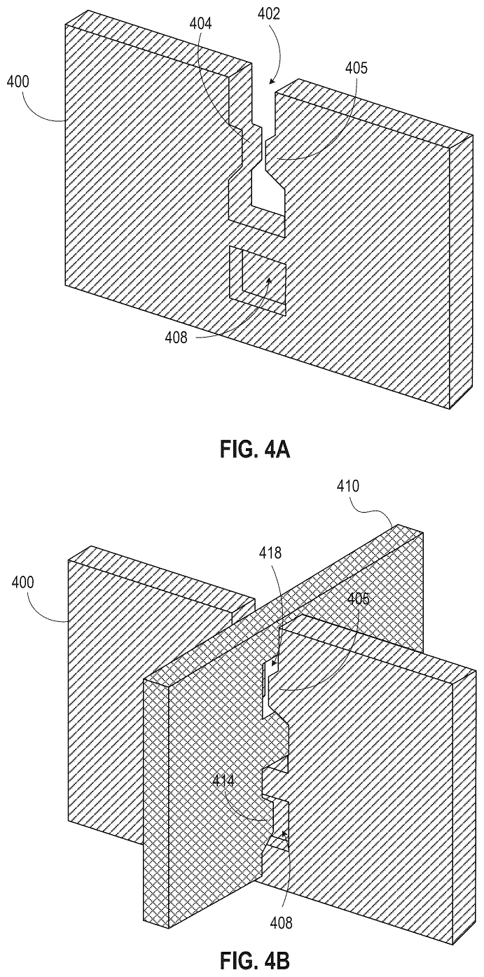

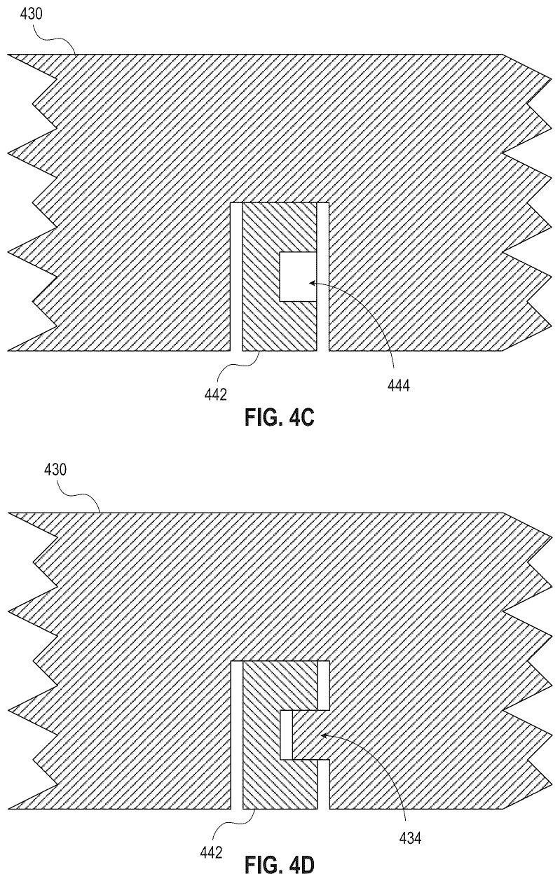

FIGS. 4A-4D are diagrammatic illustrations of slots 402 and bosses 404/405 of reusable energy absorbing layers 400, according to some embodiments. Although only one slot and aperture is shown in FIG. 4A or FIG. 4B, the energy absorbing layer 400 can include multiple slots 42, first boss 404 and second boss 405, and/or apertures 408. The slots 402 can be sufficient to accommodate a thickness of other energy absorbing layers to form a joint. For example, as shown in FIG. 4B, the energy absorbing layer 400 can couple with energy absorbing layer 410 by filling the slot 402 of energy absorbing layer 400 with that of the energy absorbing layer 410 such that the bosses 404/405 of energy absorbing layer 400 secure the energy absorbing layer 410 through an aperture 418 of the energy absorbing layer 410. First boss 414 and second boss (not shown in FIG. 4B) of the energy absorbing layer 410 can also secure the coupling via the aperture 408 of the energy absorbing layer 400, forming the joint. In some implementations, each aperture 408 is colinear with a joint along a vertical axis. In some cases, the joint can be a halved joint. In some implementations, the aperture 408 can be an opening that is not a through-hole. In some cases, the aperture 408 can include a through-hole. In some implementations the first boss 14 and second boss of the energy absorbing layer 410 can protrude inward into the slot 402 of the energy absorbing layer 400 and from opposite sides of the slot 402 such that each of the first boss 414 and the second boss converge towards a center of the slot 402 without establishing contact.

As shown in FIG. 4B, the boss 414/415 protrudes into the slot 402 and have a complementary geometry and position to engage with the aperture 418 of an adjacent layer such as the energy absorbing layer 410 when a module and/or grid of energy absorbing layers is formed. The slot 402 can also be defined by a surface of a respective layer (e.g., energy absorbing layer 410). In some cases, the slot 402 can also be defined by a different surface of a respective layer. For each energy absorbing layer, slots are uniform between each other. In some implementations, a width-defining surface of the energy absorbing layer 400 can define the aperture 408. In some cases, the aperture 408 can be offset from a formed joint. The aperture 408 can also be colinear with adjacent apertures such as aperture 418 along a horizontal axis. Each aperture can be uniform with each other. Assembled modules of absorbing layers can be organized and positioned on a board to assist in uniform energy transfer across the modules.

FIGS. 4C-4D illustrate another embodiment of a joint being formed between two energy absorbing layers via bosses and slots. Energy absorbing layer 430 can be connected with energy absorbing layer 442 via protrusions of the energy absorbing layer 442. The protrusions can include two bosses that define a gap 444. The gap 444 can be used via protrusions, such as, for example, boss 434, of the energy absorbing layer 442 to form a joint and secure both the energy absorbing layer 430 and the energy absorbing layer 442 in place.

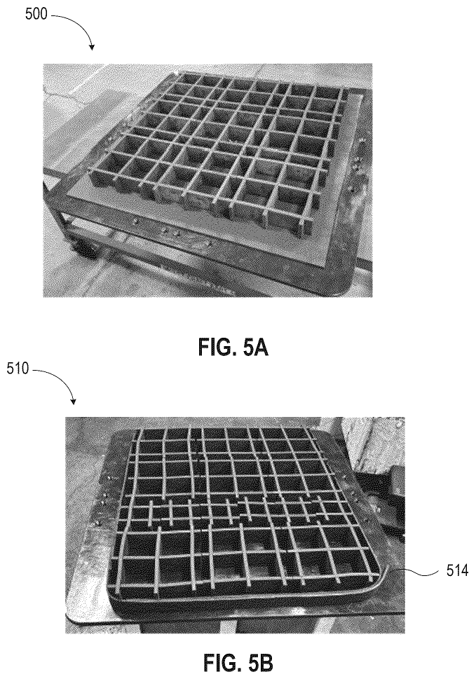

FIGS. 5A-5B are illustrative representations of a reusable skid board of the system of FIG. 1 with various combination of modules, according to some embodiments. As shown in FIG. 5A, system 500 can include a grid of modules or energy absorbing layers that is 36 inches in length and 36 inches in width having a combination of modules with different sized energy absorbing layers. As shown in FIG. 5B, the system 510 can include a grid of modules or energy absorbing layers that is 36 inches in length and 42 inches in width having a combination of modules with different sized energy absorbing layers. In some implementations, modules of energy absorbing layers forming a grid can be wrapped and/or surrounded by a belt 514 to keep the layout and structure of the grid secure. In some implementations, the grid formed by the energy absorbing layers can be a square grid, a rectangular grid, a triangular grid, a 2×2 rectangular grid, and/or the like.

In some implementation, the system for energy absorbing layers as described herein can 35 to 100 (or more) airdrops without degradation, improve readiness of users handling the energy absorbing layers and/or load, and allow for various layouts (e.g., 36×36, 36'42, 42×42, etc.) to support several types of loads, packages, and/or the like.

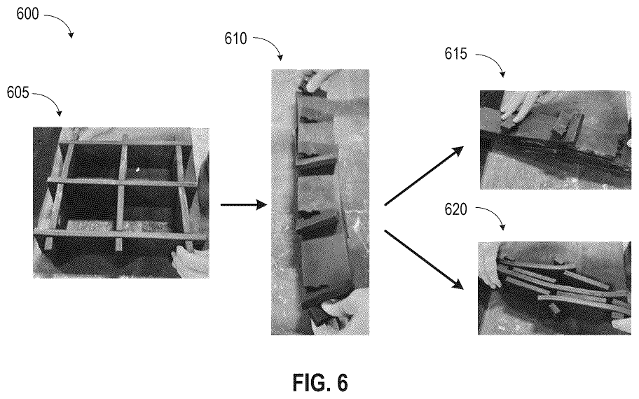

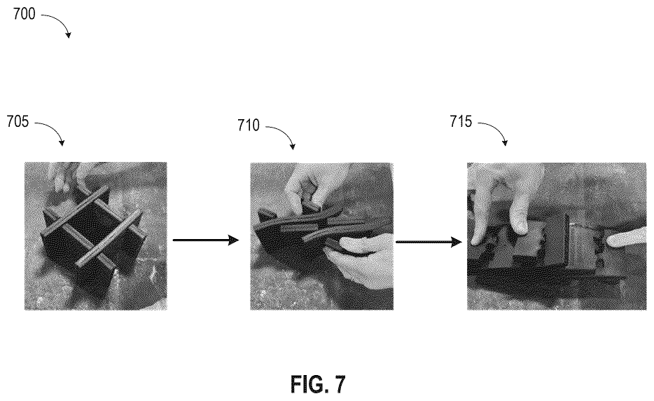

FIGS. 6-7 are illustration representations of folded modules of reusable energy absorbing layers, according to some embodiments. A method 600 for folding module 210 of FIG. 2B is shown. At 605, a user can grab protruding ends of energy absorbing layers at opposing corners of the module and pull them apart as shown in 610, resulting in a flat or thin configuration of the module. The user can further flatten the module at 615 and/or place then standing up as shown in 620 for storage and/or organization purposes.

In some implementations, a method 700 for folding module 200 of FIG. 2A is shown. At 705, a user can grab protruding ends of energy absorbing layers at opposing corners of the module 200 and press them together as shown in 710 and 715.

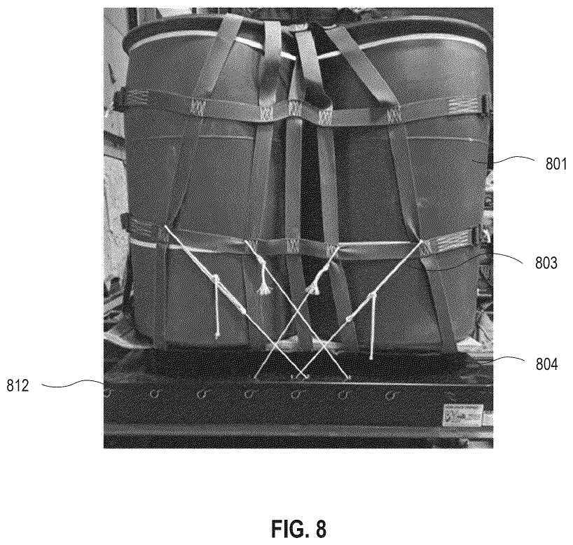

FIG. 8 is an illustrative representation of a system for reusable energy absorbing layers of FIG. 1 with a load 801, according to some embodiments. The system can support the load 801 can be any object and/or package. The load 801 can be placed on top of the energy absorbing layers 804 which is further positioned over a board 812 to provide structure and support for the load 801. The load 801 can also be secured via cordage 803 and/or netting via apertures in the board 812. In some implementations the system can be part of an airdrop load wherein at least one of the at least one modules/assemblies of energy absorbing layers is positioned below or within the airdrop load such that the grid modules/assemblies is at least partially perpendicular to an anticipated impact vector.

In some implementations, the system can be incorporated in various environments, transportation devices, and/or the like. For instance, the load 801 can be secured via the cordage 803 on the energy absorbing layers 804 which can be further loaded into an aircraft. In some instances, the board 812 can be attached to a parachute or floats such that when the load 801 is dropped from the aircraft while airborne, the load 801 can safely reach a ground surface or surface of water while reducing damage to the load from the impact via the energy absorbing layers 804, in which the force of the impact can be evenly distributed throughout the energy absorbing layers 804. In some implementations, the system can be loaded onto a ground vehicle such as, for example, a truck or other military ground transportation vehicles. The energy absorbing layers 804 and the board 812 can be designed to withstand drops on rugged terrain. In some implementations, the system can be integrated with various devices to support and/or improve handling and drop capabilities such as, for example, floats, wheels, parachutes, and/or the like.

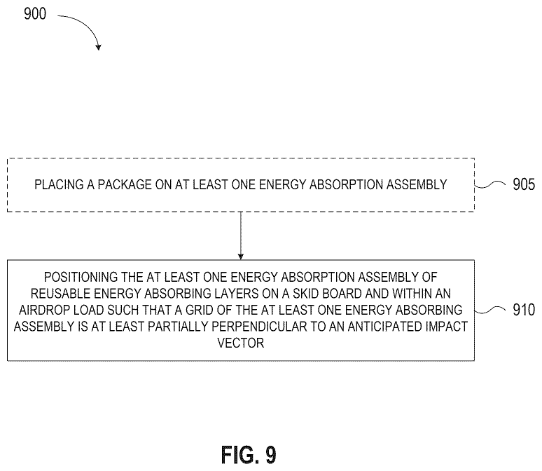

FIG. 9 is a flow diagram of a method 900 for positioning the reusable energy absorbing layers within an airdrop load, according to some embodiments. At 910, the method 900 can include positioning at least one energy absorbing assembly, module, layer, and/or pad described herein on a skid board (e.g., board 812 of FIG. 8) and within an airdrop load such that the grid of the at least one energy absorbing assembly, module, and/or pad is at least partially perpendicular to the anticipated impact vector. In some implementations, at 900, the method 900 can optionally include placing a package on the at least one energy absorbing assembly, module, layer and/or pad. In some cases, the skid board can be composed of plywood.

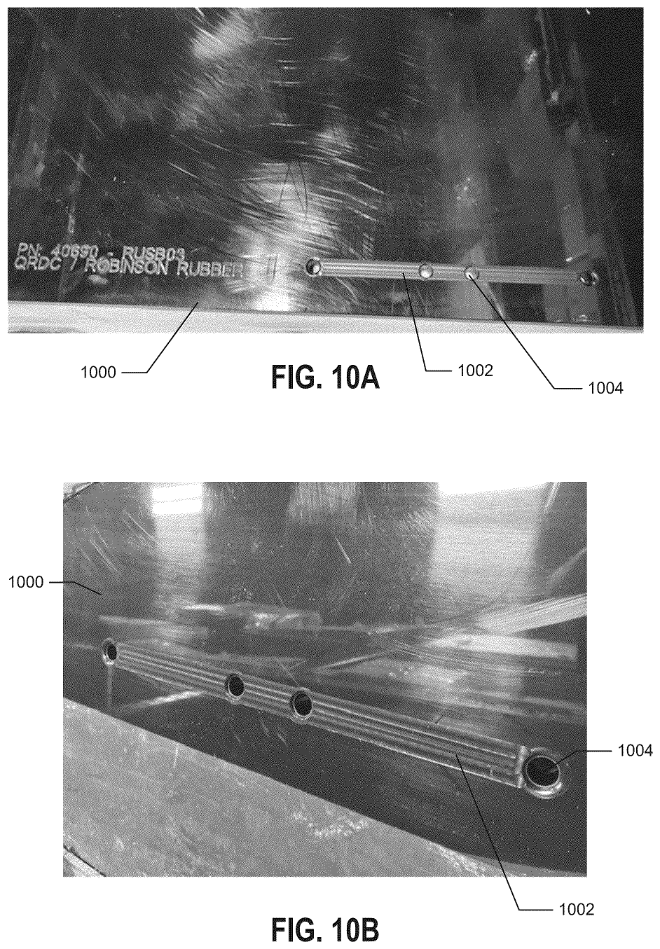

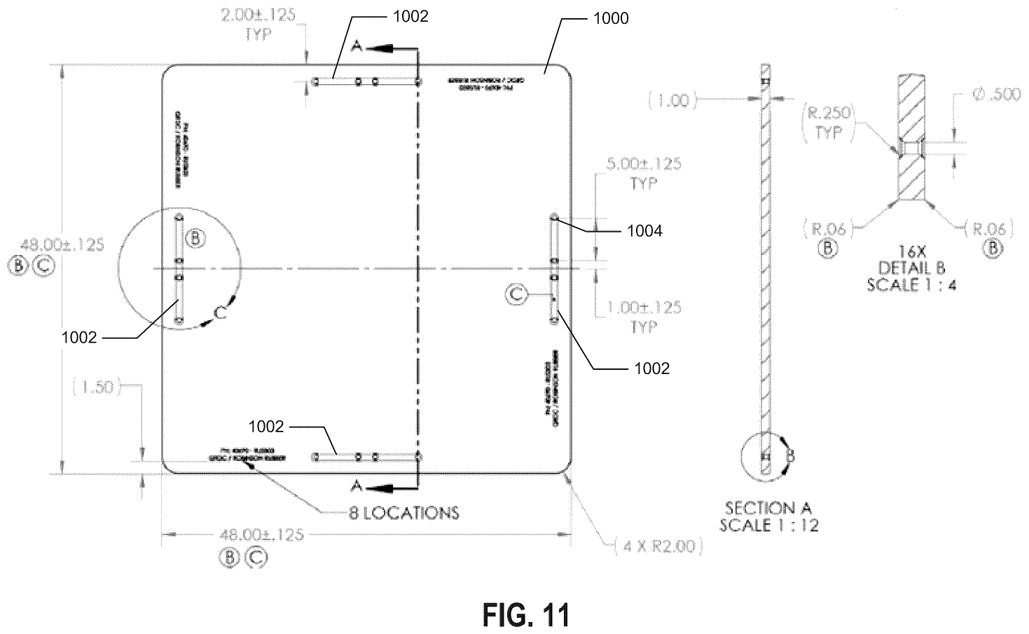

FIG. 10A shows an example of a skid board 1000 that has grooves 1002 between a plurality of holes 1004. FIG. 10B shows a closer view of the skid board 1000, grooves 1002, and holes 1004. The holes 1004 may allow for rope, cables, straps, etc., to be threaded through the skid board 1000 in order to tie down or otherwise secure a load to the skid board. FIG. 8 shows an example of this. The rope (etc.) may lie within the grooves 1002, which may reduce or prevent connected ropes from rubbing, fraying, and/or jamming against external objects, such as rollers. Skid boards 1000 may be, for example, 1 in thick or ¾ in think, and they may be, for example, 48×48 in or 24×42 in. Skid boards 1000 may be floatable or non-floatable. FIG. 11 shows an engineering drawing of an example of a skid board 1000, which has 4 grooves 1002, and 4 sets of holes 1004 (not all labeled).

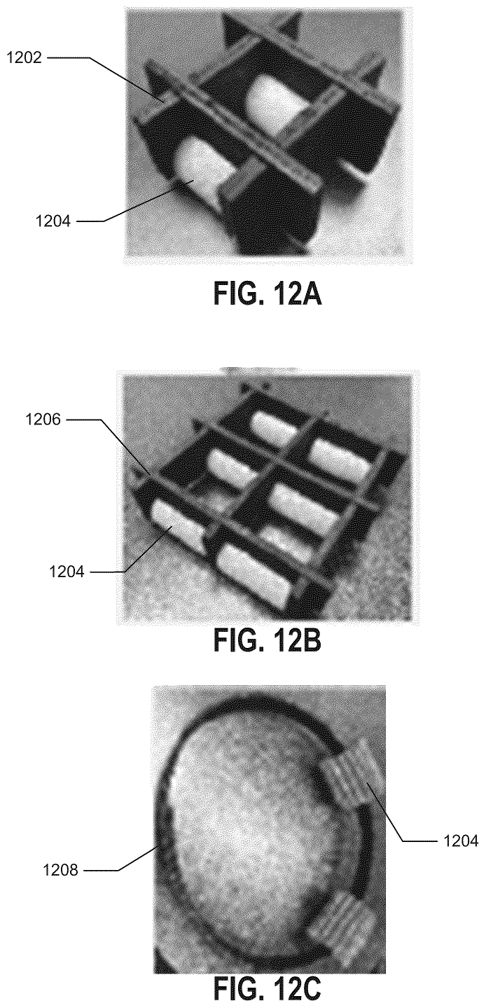

FIG. 12A shows an example of a reusable energy absorbing layer 1202 (which may be the same or similar as shown in, e.g., FIG. 1), with floatation devices 1204 affixed. The floatation devices 1204 may allow the reusable energy absorbing layer 1202 to float, which can allow to be easily recovered from a body of water after use. FIG. 12B shows an example of a larger embodiment of a reusable energy absorbing layer 1206 that has floatation devices 1204 affixed to it. The floatation devices 1204 may be, for example, foam. FIG. 12C shows an example of a belt 1208 (which may be the same or similar to belt 514, shown in FIG. 5B) that has floatation devices 1204. Like the layers 1202 and 1206, the floatation devices may allow the belt 1208 to float for easy recovery from a body of water.

FIG. 13 shows a table of example reusable energy absorbing layer embodiments. As can be seen, modules of the same size (area, height, volume) may have differing numbers of leaves (and slots). Modules with more leaves have a higher load capacity than modules with fewer leaves. For example, a 6″×6″×3″ module with 4 leaves may have a load capacity of 50 lbs, while a similarly sized module with 6 leaves may have a load capacity of 85 lbs. Modules with a higher load capacity can absorb larger forces, i.e., more energy. However, high capacity modules will generally weigh and cost more than similarly sized lower capacity modules.

All combinations of the foregoing concepts and additional concepts discussed herein (provided such concepts are not mutually inconsistent) are contemplated as being part of the subject matter disclosed herein. The terminology explicitly employed herein that also can appear in any disclosure incorporated by reference should be accorded a meaning most consistent with the particular concepts disclosed herein.

The drawings are primarily for illustrative purposes, and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments can be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments cannot have been presented for a specific portion of the innovations or that further undescribed alternate embodiments can be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments can be utilized and functional, logical, operational, organizational, structural and/or topological modifications can be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For example, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

Various concepts can be embodied as one or more methods, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

In addition, the disclosure can include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein can be implemented in a manner that enables a great deal of flexibility and customization as described herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Less specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

Unless specifically stated or obvious from context, the term “or,” as used herein, is understood to be inclusive.

The terms “proximal” and “distal” can refer to the position of a portion of a device relative to the remainder of the device or the opposing end as it appears in the drawing. The proximal end can be used to refer to the end manipulated by the user. The distal end can be used to refer to the end of the device that is inserted and advanced and is furthest away from the user. As will be appreciated by those skilled in the art, the use of proximal and distal could change in another context, e.g., the anatomical context in which proximal and distal use the patient as reference, or where the entry point is distal from the user.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An apparatus comprising:
an airdrop load; and
at least one energy absorbing assembly comprising a grid formed from a plurality of layers, each layers from the plurality of layers comprising:
a plurality of slots sufficient to accommodate a thickness of others layers from the plurality of layers and form a plurality of joints;
a plurality of apertures, each aperture from the plurality of apertures colinear with a joint from the plurality of joints along a vertical axis; and
a plurality of bosses, each boss from the plurality of bosses protruding into a slot from the plurality of slots and having a complementary geometry and position to engage with an aperture from a plurality of apertures of an adjacent layer from the plurality of layers when the grid is formed;
wherein at least one of the at least one energy absorbing assemblies is positioned below or within the airdrop load such that the grid of the energy absorbing assembly is at least partially perpendicular to an anticipated impact vector.

2. The apparatus of claim 1, wherein the plurality of layers is composed of elastomer.

3. The apparatus of claim 1, wherein the plurality of slots comprises at least three slots.

4. The apparatus of claim 1, wherein the plurality of slots is defined by a surface of a respective layer.

5. The apparatus of claim 1, wherein the plurality of slots is defined by different surfaces of a respective layer.

6. The apparatus of claim 1, wherein a shape of each of the plurality of slots is uniform between each other.

7. The apparatus of claim 1, wherein a width-defining surface of a layer of the plurality of layers defines one or more apertures.

8. The apparatus of claim 1, wherein a layer of the plurality of layers further comprises one or more air pockets.

9. The apparatus of claim 1, wherein a layer of the plurality of layers further comprises one or more metal-filled pockets.

10. The apparatus of claim 1, wherein the plurality of joints comprises halved joints.

11. The apparatus of claim 1, wherein each aperture is offset from a joint from the plurality of joints.

12. The apparatus of claim 1, wherein each aperture from the plurality of apertures is colinear with adjacent apertures from the plurality of apertures along a horizontal axis.

13. The apparatus of claim 1, wherein a shape of each aperture from the plurality of apertures is uniform with each other.

14. The apparatus of claim 1, wherein each layer from the plurality of layers is composed of styrene-butadiene rubber.

15. The apparatus of claim 1, wherein the plurality of layers can be assembled to form at least one polygon.

16. The apparatus of claim 1, wherein the grid is a square grid.

17. The apparatus of claim 1, wherein the grid is a 2×2 rectangular grid.

18. The apparatus of claim 1, wherein the grid is a rectangular grid.

19. The apparatus of claim 1, wherein the grid is a triangular grid.

20. A method comprising:
positioning the at least one energy absorbing assembly according to claim 1 on a skid board and within the airdrop load such that the grid of the at least one energy absorbing assembly is at least partially perpendicular to the anticipated impact vector.
